(19) United States
(12) Patent Application Publication
(10) Pub. No.: US 2026/0081708 A1
(43) Pub. Date: Mar. 19, 2026

(54) HIGH-SPEED DATA INPUT DEVICE AND PROCESSING METHOD FOR INPUT DATA ENABLING HIGH-SPEED TRANSMISSION

(71) Applicant: Inpsytech, Inc., Hsinchu County (TW)

(72) Inventors: Jia-Hao Lin, Hsinchu County (TW); Chun-Che Chien, Hsinchu County (TW); Yu-Hsi Wu, Hsinchu County (TW); Wei-Ren Shiue, Hsinchu County (TW)

(73) Assignee: Inpsytech, Inc., Hsinchu County (TW)

(21) Appl. No.: 18/884,843

(22) Filed: Sep. 13, 2024

(51) Int. Cl. H04J 3/06

(52) U.S. Cl. CPC H04J 3/0685

(57) ABSTRACT

A data input device includes an input circuit, a training circuit, a detection circuit, a data delay line and a clock delay line. The input circuit is configured to receive a first data signal and a first clock signal. The training circuit is configured to set a first delay setting based on the first data signal and the first clock signal. The detection circuit is configured to set a second delay setting based on the first delay setting and a clock cycle of the first clock signal. The second delay setting includes a second data delay amount and a second clock delay amount. The data delay line is configured to output a second data signal based on the first data signal and the second delay setting. The clock delay line is configured to output a second clock signal based on the first clock signal and the second delay setting.

### BACKGROUND

### Technical Field

The present invention relates to data transmission technology, in particular relates to a high-speed data input device and processing method for input data enabling high-speed transmission.

### Related Art

In circuits, such as memory circuits, clock signals are typically used as the timing reference for their operations. However, variations in temperature and voltage can cause phase shift problems in the clock signals, leading to the increase in the error rate when the memory circuit samples input data.

### SUMMARY

In some embodiments, a data input device comprises an input circuit, a training circuit, a detection circuit, a data delay line and a clock delay line. The input circuit is configured to receive a first data signal and a first clock signal. The training circuit is coupled to the input terminal circuit. The training circuit is configured to set a first delay setting based on the first data signal and the first clock signal. The first delay setting comprises a first data delay amount and a first clock delay amount. The detection circuit is coupled to the input circuit and the training circuit. The detection circuit is configured to set a second delay setting based on the first delay setting and a clock cycle of the first clock signal. The second delay setting comprises a second data delay amount and a second clock delay amount. The data delay line is coupled to the input circuit and the detection circuit. The data delay line is configured to output a second data signal based on the first data signal and the second data delay amount. The clock delay line is coupled to the input circuit and the detection circuit. The clock delay line is configured to output a second clock signal based on the first clock signal and the second clock delay amount.

In some embodiments, the clock cycle comprises a plurality of delay cell time slots. The detection circuit is configured to set the second delay setting based on the first delay setting and the number of the delay cell time slots comprised in the clock cycle.

In some embodiments, when the first delay setting is set completely, the detection circuit detects and records the number of the delay cell time slots comprised in the clock cycle as a first number, and subsequently detects the number of the delay cell time slots comprised in the clock cycle in real-time. When the detection circuit detects that the number of the delay cell time slots comprised in the clock cycle is different from the first number, the detection circuit records the detected number of the delay cell time slots comprised in the clock cycle as a second number, and sets the second delay setting based on the first delay setting, the first number, and the second number.

In some embodiments, each of the first data delay amount, the first clock delay amount, the second data delay amount, and the second clock delay amount comprises the delay cell time slots. The detection circuit adjusts the number of the delay cell time slots of the first data delay amount based on the first number and the second number to obtain the second data delay amount. The detection circuit adjusts the number of the delay cell time slots of the first clock delay amount based on the first number and the second number to obtain the second clock delay amount.

In some embodiments, the detection circuit adjusts the number of the delay cell time slots of the first data delay amount based on the ratio of the second number to the first number to obtain the second data delay amount. The detection circuit adjusts the number of the delay cell time slots of the first clock delay amount based on the ratio of the second number to the first number to obtain the second clock delay amount.

In some embodiments, the detection circuit multiplies the number of the delay cell time slots of the first data delay amount by the ratio of the second number to the first number to obtain the second data delay amount. The detection circuit multiplies the number of the delay cell time slots of the first clock delay amount by the ratio of the second number to the first number to obtain the second clock delay amount.

In some embodiments, the delay cell time slot corresponds to a delay cell. The delay cell is a buffer.

In some embodiments, a processing method for input data comprises: receiving a first data signal and a first clock signal; setting a first delay setting based on the first data signal and the first clock signal, wherein the first delay setting comprises a first data delay amount and a first clock delay amount; setting a second delay setting based on the first delay setting and a clock cycle of the first clock signal, wherein the second delay setting comprises a second data delay amount and a second clock delay amount; outputting a second data signal based on the first data signal and the second data delay amount; and outputting a second clock signal based on the first clock signal and the second clock delay amount.

In some embodiments, the clock cycle comprises a plurality of delay cell time slots. The steps of setting the second delay setting based on the first delay setting and the clock cycle of the first clock signal comprise: setting the second delay setting based on the first delay setting and the number of the delay cell time slots comprised in the clock cycle.

In some embodiments, the steps of setting the second delay setting based on the first delay setting and the clock cycle of the first clock signal comprise: detecting and recording the number of the delay cell time slots comprised in the clock cycle as a first number when the first delay setting is set completely, and subsequently detecting the number of the delay cell time slots comprised in the clock cycle in real-time; recording the detected number of the delay cell time slots comprised in the clock cycle as a second number when the number of the delay cell time slots comprised in the clock cycle is different from the first number; and setting the second delay setting based on the first delay setting, the first number, and the second number.

In some embodiments, each of the first data delay amount, the first clock delay amount, the second data delay amount, and the second clock delay amount comprises the delay cell time slots. The steps of setting the second delay setting based on the first delay setting, the first number, and the second number comprise: adjusting the number of the delay cell time slots of the first data delay amount based on the first number and the second number to obtain the second data delay amount; and adjusting the number of the delay cell time slots of the first clock delay amount based on the first number and the second number to obtain the second clock delay amount.

In some embodiments, the steps of setting the second delay setting based on the first delay setting, the first number, and the second number comprise: adjusting the number of the delay cell time slots of the first data delay amount based on the ratio of the second number to the first number to obtain the second data delay amount; and adjusting the number of the delay cell time slots of the first clock delay amount based on the ratio of the second number to the first number to obtain the second clock delay amount.

In some embodiments, the steps of setting the second delay setting based on the first delay setting, the first number, and the second number comprise: multiplying the number of the delay cell time slots of the first data delay amount by the ratio of the second number to the first number to obtain the second data delay amount; and multiplying the number of the delay cell time slots of the first clock delay amount by the ratio of the second number to the first number to obtain the second clock delay amount.

The following will describe the detailed features and advantages of the instant disclosure in detail in the detailed description. The content of the description is sufficient for any person skilled in the art to comprehend the technical context of the instant disclosure and to implement it accordingly. According to the content, claims and drawings disclosed in the instant specification, any person skilled in the art can readily understand the goals and advantages of the instant disclosure.

### BRIEF DESCRIPTION OF DRAWINGS

The disclosure will become more fully understood from the detailed description given herein below for illustration only, and thus not limitative of the disclosure, wherein:

FIG. 1 illustrates a schematic diagram of an embodiment of a data input device and a output circuit.

FIG. 2 illustrates a flowchart of an embodiment of a processing method for input data.

FIG. 3A illustrates a schematic diagram of an embodiment of a first data signal and a first clock signal when emitted by the output circuit.

FIG. 3B illustrates a schematic diagram of an embodiment of the first data signal and the first clock signal when received by a input circuit.

FIG. 4A-4C illustrates schematic diagrams of an embodiment of a training procedure for a training circuit.

FIG. 5 illustrates a schematic diagram of an embodiment of the first data signal and the first clock signal after the training procedure and after being affected by temperature and voltage.

FIG. 6 illustrates a schematic diagram of an embodiment of a clock cycle.

FIG. 7 illustrates a flowchart of an embodiment of step S03.

### DETAILED DESCRIPTION

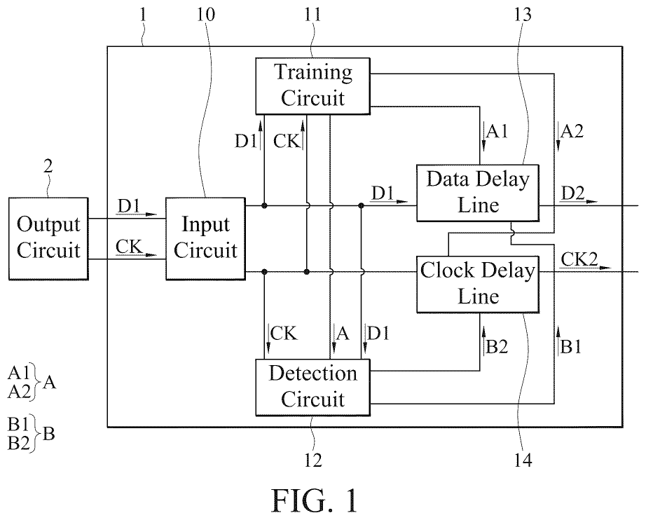

Please refer to FIG. 1. A data input device 1 comprises an input circuit 10, a training circuit 11, a detection circuit 12, a data delay line 13, and a clock delay line 14. The training circuit 11 is coupled to the input circuit 10, the detection circuit 12, the data delay line 13, and the clock delay line 14. The detection circuit 12 is coupled to the input circuit 10, the training circuit 11, the data delay line 13, and the clock delay line 14.

In some implementations, the data input device 100 may be applied to a transmission interface. For example, the transmission interface of a memory, such as a dynamic random access memory (DRAM), the transmission interface of a die-to-die, and the like, but the present invention is not limited thereto; the data input device 100 may be applied to any transmission interface. Furthermore, the data input device 100 may be implemented in a chip form through an integrated circuit process.

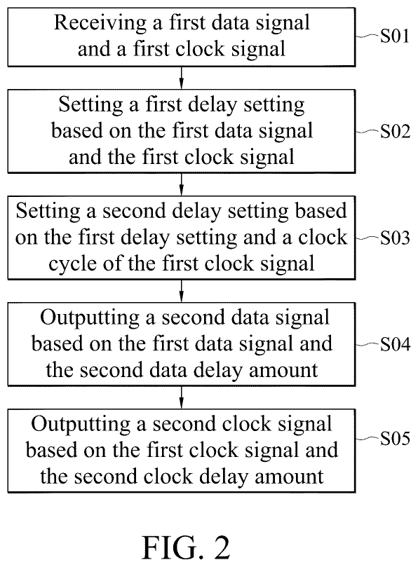

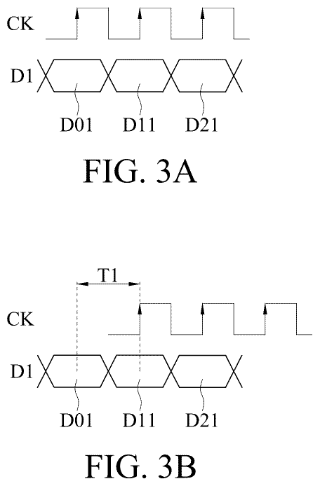

Please refer to FIG. 1 and FIG. 2. The input circuit 10 is configured to receive a first data signal D1 and a first clock signal CK from a output circuit 2 (step S01). Please refer to FIG. 3A. In some embodiments, the first data signal D1 comprises multiple pieces of data. For convenience of illustration, in FIG. 3A, the first data signal D1 comprises only three pieces of data, namely data D01, data D11, and data D21, but the number of data pieces comprised in the first data signal D1 is not limited thereto. In some embodiments, when the first data signal D1 and the first clock signal CK are emitted from the output circuit 2, the positive and/or negative edges of the first clock signal CK hit (locate at) the central position of each piece of data comprised in the first data signal D1. FIG. 3A shows an embodiment where the positive edge of the first clock signal CK hits the central position of each piece of data comprised in the first data signal D1. Please refer to FIG. 3B. In some embodiments, when the input circuit 10 receives the first data signal D1 and the first clock signal CK, a skew T1 occurs between the first data signal D1 and the first clock signal CK. The skew T1 causes the positive edge of the first clock signal CK to be unable to correctly hit the central position of each piece of data comprised in the first data signal D1. In the embodiment of FIG. 3B, the skew T1 causes the first data signal D1 to be faster than the first clock signal CK, resulting in the first positive edge of the first clock signal CK hitting data D11 instead of the expected data D01.

In some embodiments, the output circuit 2 may be a memory circuit. In some embodiments, the output circuit 2 may be volatile storage media, non-volatile storage media, or a combination thereof. Volatile storage media include, for example, Random Access Memory (RAM), such as Static Random Access Memory (SRAM) or Dynamic Random Access Memory (DRAM). Non-volatile storage media include, for example, Read-Only Memory (ROM), such as Programmable Read-Only Memory (PROM), Erasable Programmable Read-Only Memory (EPROM), Electrically Erasable Programmable Read-Only Memory (EEPROM), One-Time Programmable Read-Only Memory (OTPROM), or Flash Memory. The type of the output circuit 2 is not limited herein.

In some embodiments, the first clock signal CK may be a global clock generated by a clock source, such as but not limited to an oscillator. Additionally, the first clock signal CK may be delayed by a clock tree, but the present invention is not limited thereto.

In some embodiments, the transmission speed of the first data signal D1 and the first clock signal CK may be but not limited to 16 Gbps or 32 Gbps.

In some embodiments, the skew T1 is caused by the physical metal wires between the output circuit 2 and the input circuit 10.

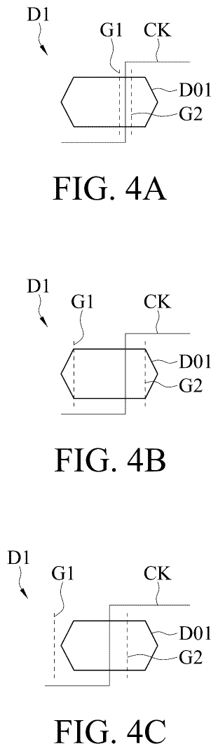

In some embodiments, the training circuit 11 is configured to perform a training procedure to set a first delay setting A (step S02) based on the first data signal D1 and the first clock signal CK, thereby correcting the skew T1. The first delay setting A comprises a first data delay amount A1 and a first clock delay amount A2. Please refer to FIG. 4A to FIG. 4C. In some embodiments, during the training procedure of the training circuit 11, in order to cause the positive or negative edge of the first clock signal CK to hit (or locate at) the central position of a piece of current data D01 of the first data signal D1 (take the positive edge of the first clock signal CK shown in FIG. 4C for example), the data input device 1 may use the training circuit 11 to detect the relationship between the first data signal D1 and the first clock signal CK and correspondingly set the first data delay amount A1 and the first clock delay amount A2. During the training procedure, the data pattern of the first data signal D1 is known to the training circuit 11. For example, assuming the data pattern of the first data signal D1 is “010” and the current data D01 is “1,” the relationship between the first data signal D1 and the first clock signal CK can be as shown in FIG. 4A. First, the training circuit 11 adjusts a left indicator G1 and a right indicator G2 until reaching the boundaries of the current data D01. The training circuit 11 can determine whether the left indicator G1 has been adjusted to the left boundary of the current data D01 based on whether the data sampled at the left indicator G1 is “0”, and the training circuit 11 can also determine whether the right indicator G2 has been adjusted to the right boundary of the current data D01 based on whether the data sampled at the right indicator G2 is “0”. After the left indicator G1 and the right indicator G2 are respectively adjusted to the boundaries of the current data D01, as shown in FIG. 4B, the training circuit 11 can obtain a data length according to the distance between the left indicator G1 and the right indicator G2 and find the central position of the current data D01 according to the data length. After that, the training circuit 11 can set the first data delay amount A1 and the first clock delay amount A2 based on the central position, thereby completing the training procedure of the data input device 1. In this embodiment, the training circuit 11 increases the delay amount of the first data signal D1 (i.e., the first data delay amount A1), as shown in FIG. 4C. In some embodiments, the initial values of both the first data delay amount A1 and the first clock delay amount A2 are 0 seconds(s).

In FIG. 3B and FIG. 4A to FIG. 4C, the skew T1 is illustrated with the first data signal D1 being faster than the first clock signal CK, but the present invention is not limited thereto. In some embodiments, the skew T1 may also cause the first clock signal CK to be faster than the first data signal D1. In some embodiments, when the skew T1 causes the first clock signal CK to be faster than the first data signal D1, the training circuit 11 increases the delay amount of the first clock signal CK (i.e., the first clock delay amount A2).

Through performing the training procedure, the training circuit 11 can determine the duration of the skew T1 and increase either the first data delay amount A1 or the first clock delay amount A2 based on the duration of the skew T1. For example, if the duration of the skew T1 shown in FIG. 3B is 200 picoseconds (ps), and because the first data signal D1 is faster than the first clock signal CK, after the training procedure is performed, the training circuit 11 sets the first data delay amount A1 to 200 ps.

In some embodiments, after the training circuit 11 determines the first delay setting A, the training circuit 11 transmits the first data delay amount A1 to the data delay line 13 and transmits the first clock delay amount A2 to the clock delay line 14. The data delay line 13, based on the first data signal D1 and the first data delay amount A1, outputs the first data signal D1 with the added delay amount, which is then provided to a data processing unit (not shown in FIGs). The clock delay line 14, based on the first clock signal CK and the first clock delay amount A2, outputs the first clock signal CK with the added delay amount, which is also provided to the data processing unit. In this embodiment, the positive and/or negative edges of the first clock signal CK output by the clock delay line 14 will correctly hit the central position of each piece of data comprised in the first data signal D1 output by the data delay line 13.

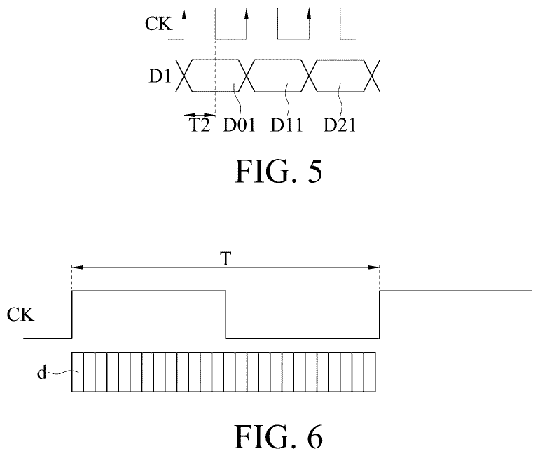

However, in some embodiments, during the operation of the data input device 1, after the skew T1 is corrected by the training circuit 11, the first clock signal CK and the first data signal D1 may still experience a new skew T2 due to variations such as temperature and voltage. Please refer to FIG. 5. The skew T2 causes the positive edge of the first clock signal CK, which had been corrected for the skew T1, to no longer correctly hit the central position of each piece of data comprised in the first data signal D1. In the embodiment shown in FIG. 5, the skew T2 causes the first clock signal CK, after the correction of the skew T1, to become faster than the first data signal D1, resulting in the positive edge of the first clock signal CK failing to hit the expected data correctly. In other words, the first data delay amount A1 and the first clock delay amount A2 set by the training circuit 11 to correct the skew T1 are insufficient to cope with the effects caused by the skew T2.

In some embodiments, the detection circuit 12 is configured to set a second delay setting B (step S03) based on the first delay setting A and a clock cycle T of the first clock signal CK, thereby correcting the skew T2. The second delay setting B comprises a second data delay amount B1 and a second clock delay amount B2. Please refer to FIG. 6. In some embodiments, the clock cycle T comprises a plurality of delay cell time slots d. The detection circuit 12 is configured to set the second delay setting B based on the first delay setting A and the number of the delay cell time slots d comprised in the clock cycle T.

In some embodiments, the delay cell time slot d corresponds to a delay cell. The number of the delay cell time slots d comprised in the clock cycle T represents that the time duration of the clock cycle T is the time required for a signal to pass through the corresponding number of delay cells corresponding to the delay cell time slots d comprised in the clock cycle T. For example, if the number of the delay cell time slots d comprised in the clock cycle T is 100, the time duration of the clock cycle T is the time required for a signal to pass through 100 delay cells. In some embodiments, the delay cell is a buffer.

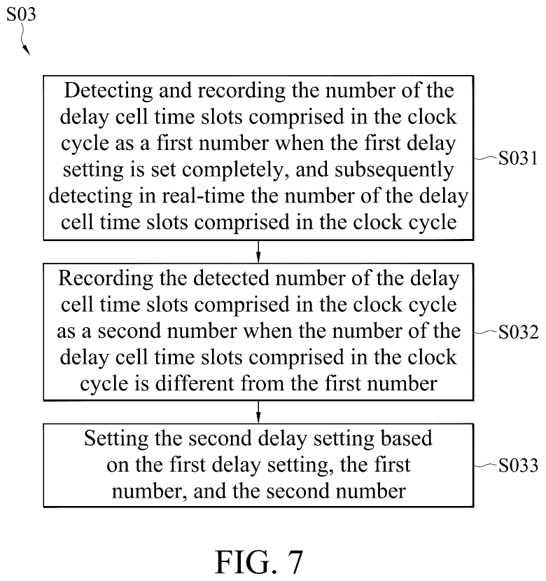

Please refer to FIG. 7. In some embodiments, when the detection circuit 12 performs the step S03, the detection circuit 12 first detects and records the number of the delay cell time slots d comprised in the clock cycle T as a first number (step S031) when the training circuit 11 has completed setting the first delay setting A. The detection circuit 12 then subsequently detects the number of the delay cell time slots d comprised in the clock cycle T in real-time. When the detection circuit 12 detects that the number of the delay cell time slots d comprised in the clock cycle T is different from the first number, the detection circuit 12 records the detected number of the delay cell time slots d comprised in the clock cycle T as a second number (step S032). Then, the detection circuit 12 sets the second delay setting B based on the first delay setting A, the first number, and the second number (step S033). For example, assuming that when the training circuit 11 has completed setting the first delay setting A, the number of the delay cell time slots d comprised in the clock cycle T is 100, the detection circuit 12 detects and records 100 as the first number and then subsequently detects the number of the delay cell time slots d comprised in the clock cycle T in real-time. When the detection circuit 12 detects that the number of the delay cell time slots d comprised in the clock cycle T is 80, since 80 is different from the first number (i.e., 100), the detection circuit 12 records the detected 80 as the second number. Then, the detection circuit 12 sets the second delay setting B based on the first delay setting A, the first number (i.e., 100), and the second number (i.e., 80).

The reason why the number of the delay cell time slots d comprised in the clock cycle T is different at different times (i.e., the values of the first number and the second number are different) is due to the influence of variations in temperature, voltage, and other variations on the delay cells. For example, if the first number is 100 and the second number is 80, it indicates that the time duration of the clock cycle T has changed from the time required for a signal to pass through 100 delay cells to the time required for a signal to pass through 80 delay cells. In other words, the time required for a signal to pass through a single delay cell has increased, and the reason for this increase is the influence of variations in temperature, voltage, and other variations on the delay cells. Assuming that the time duration of the clock cycle T is 200 ps, since the time duration of the clock cycle T is fixed, when the number of the delay cell time slots d comprised in the clock cycle T is equal to the first number, the time required for a signal to pass through a single delay cell is 2 ps (200 ps/100=2 ps). When the number of the delay cell time slots d comprised in the clock cycle T is equal to the second number, the time required for a signal to pass through a single delay cell is 2.5 ps (200 ps/80=2.5 ps).

In some embodiments, each of the first data delay amount A1, the first clock delay amount A2, the second data delay amount B1, and the second clock delay amount B2 also comprises the delay cell time slots d. Similarly, as mentioned above, the number of the delay cell time slots d comprised in the first data delay amount A1, the first clock delay amount A2, the second data delay amount B1, and the second clock delay amount B2 represents that the time duration of the first data delay amount A1, the first clock delay amount A2, the second data delay amount B1, and the second clock delay amount B2 is the time required for a signal to pass through the number of the delay cells corresponding to the number of the delay cell time slots d comprised in the first data delay amount A1, the first clock delay amount A2, the second data delay amount B1, and the second clock delay amount B2.

In some embodiments, the training circuit 11 sets the first data delay amount A1 and the first clock delay amount A2 by setting the number of the delay cell time slots d comprised in the first data delay amount A1 and the first clock delay amount A2. Taking FIG. 3B as an example, if the time duration of the skew T1 shown in FIG. 3B is 200 ps, and since the first data signal D1 is faster than the first clock signal CK, after the training circuit 11 performs the training procedure, if the time required for a signal to pass through a single delay cell is 2 ps, the training circuit 11 will set the number of the delay cell time slots d comprised in the first data delay amount A1 to be 100, so that the time duration of the first data delay amount A1 is 200 ps. It should be noted that when variations in temperature, voltage, and other variations affect the delay cells and change the time required for a signal to pass through a single delay cell, the skew caused by the number of the delay cell time slots d set by the training circuit 11 for the first data delay amount A1 and the first clock delay amount A2 is referred to as the skew T2. Following the above example, if variations in temperature, voltage, and other variations increase the time required for a signal to pass through a single delay cell from 2 ps to 2.5 ps, since the number of the delay cell time slots d comprised in the first data delay amount A1 is 100 at this time, the time duration of the first data delay amount A1 will be 250 ps (2.5 ps*100=250 ps), instead of the originally expected 200 ps. This results in an excessive delay in the first data signal D1 after the correction of the skew T1, making the first clock signal CK, after the correction of skew T1, faster than the first data signal D1 by 50 ps. The 50 ps difference caused by the influence of variations in temperature, voltage, and other variations is the skew T2.

In some embodiments, when the detection circuit 12 executes step S033, the detection circuit 12 adjusts the number of the delay cell time slots d of the first data delay amount A1 based on the first number and the second number to obtain the second data delay amount B1. Similarly, the detection circuit 12 adjusts the number of the delay cell time slots d the first clock delay amount A2 based on the first number and the second number to obtain the second clock delay amount B2. For example, if the first number is 100, the second number is 80, the time duration of the clock cycle T is 200 ps, and the number of the delay cell time slots d of the first data delay amount A1 is 100, since the time required for a signal to pass through a single delay cell has increased from 2 ps (200 ps/100=2 ps) to 2.5 ps (200 ps/80=2.5 ps), the time duration of the first data delay amount A1 becomes 250 ps (2.5 ps*100=250 ps) instead of the originally expected 200 ps. Therefore, to maintain the delay amount at 200 ps, the detection circuit 12 adjusts the number of the delay cell time slots d of the first data delay amount A1 to 80 to keep the delay amount at 200 ps (2.5 ps*80=200 ps). The first data delay amount A1, which now has 80 delay cell time slots d, becomes the second data delay amount B1.

In some embodiments, when the detection circuit 12 executes step S033, the detection circuit 12 adjusts the number of the delay cell time slots d of the first data delay amount A1 based on the ratio of the second number to the first number to obtain the second data delay amount B1. Similarly, the detection circuit 12 adjusts the number of the delay cell time slots d of the first clock delay amount A2 based on the ratio of the second number to the first number to obtain the second clock delay amount B2. In some embodiments, the detection circuit 12 multiplies the number of the delay cell time slots d of the first data delay amount A1 by the ratio of the second number to the first number to obtain the second data delay amount B1. Similarly, the detection circuit 12 multiplies the number of the delay cell time slots d of the first clock delay amount A2 by the ratio of the second number to the first number to obtain the second clock delay amount B2. For example, assuming the first number is 100, the second number is 80, and the number of the delay cell time slots d of the first data delay amount A1 is 100, the detection circuit 12 multiplies the number of the delay cell time slots d of the first data delay amount A1 (i.e., 100) by the ratio of the second number to the first number (i.e., 80/100=0.8) to obtain the second data delay amount B1 with 80 delay cell time slots d (100*0.8=80).

In FIG. 5, the illustration is based on the scenario where the skew T2 causes an excessive delay in the first data signal D1 after the correction of the skew T1, resulting in the first clock signal CK being faster than the first data signal D1 after the correction of the skew T1, but the present invention is not limited thereto. In some embodiments, the skew T2 may cause an excessive delay in the first clock signal CK after the correction of skew T1, resulting in the first data signal D1 being faster than the first clock signal CK after the correction of skew T1.

In some embodiments, the data delay line 13 is configured to output a second data signal D2, which is provided to the data processing unit (not shown in FIGs) based on the first data signal D1 and the second data delay amount B1 (step S04). The clock delay line 14 is configured to output a second clock signal CK2, which is provided to the data processing unit based on the first clock signal CK and the second clock delay amount B2 (step S05). At this time, the positive and/or negative edges of the second clock signal CK2 output by the clock delay line 14 will correctly hit the central position of each piece of data comprised in the second data signal D2 output by the data delay line 13.

To sum up, the data input device 1 of any embodiment can perform the processing method for input data of any embodiment on the first data signal D1 and the first clock signal CK, so that the positive and/or negative edges of the second clock signal CK2 can correctly hit the central position of each piece of data comprised in the second data signal D2. Furthermore, even if there is a skew T2 caused by the influence of temperature, voltage, and other variations, the data input device 1 performing the processing method for input data of any embodiment can correct the skew T2 without interrupting data transmission, thereby achieving high-speed data transmission.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A data input device, comprising:
an input circuit configured to receive a first data signal and a first clock signal;
a training circuit, coupled to the input terminal circuit, configured to set a first delay setting based on the first data signal and the first clock signal, wherein the first delay setting comprises a first data delay amount and a first clock delay amount;
a detection circuit, coupled to the input circuit and the training circuit, configured to set a second delay setting based on the first delay setting and a clock cycle of the first clock signal, wherein the second delay setting comprises a second data delay amount and a second clock delay amount;
a data delay line, coupled to the input circuit and the detection circuit, configured to output a second data signal based on the first data signal and the second data delay amount; and
a clock delay line, coupled to the input circuit and the detection circuit, configured to output a second clock signal based on the first clock signal and the second clock delay amount.

2. The data input device according to claim 1, wherein the clock cycle comprises a plurality of delay cell time slots, and the detection circuit is configured to set the second delay setting based on the first delay setting and the number of the delay cell time slots comprised in the clock cycle.

3. The data input device according to claim 2, wherein, when the first delay setting is set completely, the detection circuit detects and records the number of the delay cell time slots comprised in the clock cycle as a first number, and subsequently detects the number of the delay cell time slots comprised in the clock cycle in real-time, and when the detection circuit detects that the number of the delay cell time slots comprised in the clock cycle is different from the first number, the detection circuit records the detected number of the delay cell time slots comprised in the clock cycle as a second number, and sets the second delay setting based on the first delay setting, the first number, and the second number.

4. The data input device according to claim 3, wherein each of the first data delay amount, the first clock delay amount, the second data delay amount, and the second clock delay amount comprises the delay cell time slots, the detection circuit adjusts the number of the delay cell time slots of the first data delay amount based on the first number and the second number to obtain the second data delay amount, and the detection circuit adjusts the number of the delay cell time slots of the first clock delay amount based on the first number and the second number to obtain the second clock delay amount.

5. The data input device according to claim 4, wherein the detection circuit adjusts the number of the delay cell time slots of the first data delay amount based on the ratio of the second number to the first number to obtain the second data delay amount, and the detection circuit adjusts the number of the delay cell time slots of the first clock delay amount based on the ratio of the second number to the first number to obtain the second clock delay amount.

6. The data input device according to claim 5, wherein the detection circuit multiplies the number of the delay cell time slots of the first data delay amount by the ratio of the second number to the first number to obtain the second data delay amount, and the detection circuit multiplies the number of the delay cell time slots of the first clock delay amount by the ratio of the second number to the first number to obtain the second clock delay amount.

7. The data input device according to claim 6, wherein the delay cell time slot corresponds to a delay cell, and the delay cell is a buffer.

8. A processing method for input data, comprising:
receiving a first data signal and a first clock signal;
setting a first delay setting based on the first data signal and the first clock signal, wherein the first delay setting comprises a first data delay amount and a first clock delay amount;
setting a second delay setting based on the first delay setting and a clock cycle of the first clock signal, wherein the second delay setting comprises a second data delay amount and a second clock delay amount;
outputting a second data signal based on the first data signal and the second data delay amount; and
outputting a second clock signal based on the first clock signal and the second clock delay amount.

9. The processing method for input data according to claim 8, wherein the clock cycle comprises a plurality of delay cell time slots, and the steps of setting the second delay setting based on the first delay setting and the clock cycle of the first clock signal comprise:
setting the second delay setting based on the first delay setting and the number of the delay cell time slots comprised in the clock cycle.

10. The processing method for input data according to claim 9, wherein the steps of setting the second delay setting based on the first delay setting and the clock cycle of the first clock signal comprise:
detecting and recording the number of the delay cell time slots comprised in the clock cycle as a first number when the first delay setting is set completely, and subsequently detecting the number of the delay cell time slots comprised in the clock cycle in real-time;
recording the detected number of the delay cell time slots comprised in the clock cycle as a second number when the number of the delay cell time slots comprised in the clock cycle is different from the first number; and
setting the second delay setting based on the first delay setting, the first number, and the second number.

11. The processing method for input data according to claim 10, wherein each of the first data delay amount, the first clock delay amount, the second data delay amount, and the second clock delay amount comprises the delay cell time slots, the steps of setting the second delay setting based on the first delay setting, the first number, and the second number comprise:
adjusting the number of the delay cell time slots of the first data delay amount based on the first number and the second number to obtain the second data delay amount; and
adjusting the number of the delay cell time slots of the first clock delay amount based on the first number and the second number to obtain the second clock delay amount.

12. The processing method for input data according to claim 11, wherein the steps of setting the second delay setting based on the first delay setting, the first number, and the second number comprise:
adjusting the number of the delay cell time slots of the first data delay amount based on the ratio of the second number to the first number to obtain the second data delay amount; and
adjusting the number of the delay cell time slots of the first clock delay amount based on the ratio of the second number to the first number to obtain the second clock delay amount.

13. The processing method for input data according to claim 12, wherein the steps of setting the second delay setting based on the first delay setting, the first number, and the second number comprise:
multiplying the number of the delay cell time slots of the first data delay amount by the ratio of the second number to the first number to obtain the second data delay amount; and
multiplying the number of the delay cell time slots of the first clock delay amount by the ratio of the second number to the first number to obtain the second clock delay amount.

14. The processing method for input data according to claim 13, wherein the delay cell time slot corresponds to a delay cell, and the delay cell is a buffer.
